(19) United States
(12) Patent Application Publication
(10) Pub. No.: US 2016/0089669 A1
(43) Pub. Date: Mar. 31, 2016

(54) Apparatus for Multiplex Extraction of Biological Samples and In-Transit Preparation of the Same

(71) Applicant: Novilytic, LLC, North Webster, IN (US)

(72) Inventors: Fred Regnier, West Lafayette, IN (US); Jinhee Kim, West Lafayette, IN (US); Jiri Adamec, Denton, NE (US); Timothy E. Woenker, Fort Wayne, IN (US); Richard P. Zoltek, Columbia City, IN (US)

(21) Appl. No.: 14/867,722

(22) Filed: Sep. 28, 2015

Related U.S. Application Data
(60) Provisional application No. 62/056,179, filed on Sep. 26, 2014.

(51) Int. Cl. B01L 3/00

(52) U.S. Cl. CPC B01L 3/502; B01L 2300/0887; B01L 2300/0681; B01L 2300/041; B01L 2300/165; B01L 2200/06; B01L 2300/0609

(57) ABSTRACT

The invention relates to a device for the rapid simultaneous collection, and, optionally, treatment or standardization, of multiple aliquots of a liquid biological sample such as blood from a single source drop or sample portion, the device comprising device comprising a cover, a spreading layer comprising a macroporous membrane adjacent to the cover, where the spreading layer comprises a transport portion and at least one accumulation portion in fluid connection with the transport portion, and at least one collection portion in fluid connection with each accumulation portion.

### INCORPORATION BY REFERENCE AND PRIORITY CLAIM

This application is a non-provisional of, and claims priority to, U.S. Patent Application No. 62/056,179, Apparatus for Multiplex Extraction of Biological Samples and In-Transit Preparation of the Same, filed on Sep. 26, 2014.

This Application is related to PCT Application Apparatus for Multiplex Extraction of Biological Samples and In-Transit Preparation of the Same filed contemporaneously herewith.

This patent application incorporates by reference the specifications and drawings of U.S. Patent Application No. 62/030,930, filed Jul. 30, 2014, and U.S. patent application Ser. No. 13/833,402, filed Mar. 15, 2013, as if set forth and reproduced fully herein.

### BACKGROUND

It is common in biological research and diagnostics to collect a biological sample at one site, and to subject that sample to multiple tests or forms of analysis at a site or sites different from the point of collection. A number of biological fluids are routinely selected for sampling for a variety of reasons and to detect a variety of analytes of interest. Representative biological fluids frequently sampled include, for example, cell lysates, cellular growth medium, saliva, urine, cerebral spinal fluid (CSF), inter-cellular fluid, and blood.

Collection of such biological samples, and maintaining the chemical integrity of analytes of interest within the sample during transit, and reliable division of the sample into smaller test samples that contain representative quantities of analytes of interest are all problems known to the art. One current approach to these related problems is to collect biological samples in volumes of 1 mL or greater. Large sample volumes, and storage of such large samples in controlled conditions, mitigates degradation of analytes of interest and facilitates further division of the sample for testing. It is also known to the art to subject samples to preliminary preparation after collection by prior to testing to separate analytes of interest or to stabilize chemical compounds that are analytes of interest. It is also known to the art to preserve a sample, for example by cooling or freezing, during transit. It is also known to the art to divide samples for further testing by, in laboratory conditions, splitting the sample into fractions, with each fraction to undergo a test. Such splitting can be accomplished by, for example, automated or robotic pipetting of the sample into volume-determined aliquots.

As the sensitivity of modern analytical instrumentation increases, however, it is increasingly desirable to have biological samples of a volume much smaller than mL scale. Reducing sample size by means known to the art, however, presents its own sets of problems. Microliter-scale volumes, for example, are too small to be handled by conventional systems.

A central component in preparing biological samples for analysis by means known to the art is the removal of particles other than analytes of interest within the sample. The step of particle removal is typically achieve by centrifugation, especially when dealing with samples of one mL or more in volume. Centrifugation is, however, a time consuming process and is particularly problematic, if not impossible, for samples with a volume of less than one mL scale.

One method of collecting and preparing the common biological sample of fluid blood for analysis is venipuncture followed by refrigeration and centrifugation of the sample. Venipuncture collection, however, requires a phlebotomist to draw the blood, specialized tubes for collection, and a technician with a centrifuge and refrigeration to store samples; all of which is time consuming and expensive. Further, this method requires relatively large volumes of sample; generally in the range of 1-10 mL. Modern analytical instruments such as a mass spectrometers (MS) are generally able to determine the presence of analytes of interest (or “diagnostic analytes”) in sample sizes in the uL, range, and specifically in sample sizes between 1 and 100 uL. Because a drop of liquid is from 15-50 uL in volume, depending on the viscosity and surface tension, finger- and heal-slick blood sampling can be used to provide analyzable samples.

It is thus known to the art to take drops of blood via heel or finger sticking and collect those drops on paper to dry, or in microfabricated small collection devices. Collection of blood drops on paper, such as a “Guthrie card,” then drying the resulting spots and extracting and analyzing analytes of interest in a laboratory is well known to the art. Dried blood spot collection has a variety of problems, however. For example, extraction of the dried blood from the paper removes substances from dried blood cells, increasing sample complexity and contributing to matrix suppression of ionization in mass spectrometry. In addition, hematocrit impacts the spread of liquid blood on the paper collection surface. As hematocrit increases, the area across which a volume of blood spreads on paper decreases. Thus, the size of a dried blood spot is not necessarily related to the volume of whole blood applied to the collection paper. In fact, using the dried blood spot collection method, there is often no way to accurately determine the volume of the blood deposited on the piece of paper. This severely complicates quantification of analytes of interest within the sample, such as determining metabolite, drug, and protein concentrations

It is also known to collect drop-sized samples using microfabricated devices such as a plasma separation device, or PSD. A representative plasma separation device known to the art is described, for example, in U.S. Pat. No. 4,839,296 comprises a device that separates and aliquots a plasma sample of predetermined volume from a whole blood sample of sufficient size applied to the surface of the PSD. A PSD generally comprises a removable holding member, a blood introducing member in the holding member, a spreading layer member in communication with the blood introducing member, a semi-permeable separation member in communication with the spreading layer member, and a collection reservoir of defined volume in communication with the semi-permeable separation member, wherein when a whole blood sample is deposited on the blood introducing member, plasma from the sample passes through the spreading layer member to the separation member, is separated by the separation member, and is collected in a pre-determined volume by the collection reservoir. The collection reservoir may optionally further contain or comprise an absorptive material element, which absorbs substantially all of a collected plasma sample. The collection reservoir may be removed for convenient isolation of the collected plasma sample. The collected plasma sample may then be transferred to a preparation vessel for further processing, or, optionally, an absorptive material element or “collection disc” that has substantially absorbed a collected plasma sample may be so transferred. A PSD may optionally be used for collection of other liquid or liquefied biological samples, including, for example, blood components, saliva, semen, cerebrospinal fluid, urine, tears and homogenized or extracted biosamples (i.e. from a whole organism, organ, tissue, hair, or bone).

PSDs known to the art perform a limited number of preparatory steps to a sample, such as particulate removal. The PSD comprises in essence a membrane stack covered with an impermeable overlay bearing an entry hole. The membrane stack rests on a hydrophobic isolation screen that precludes plasma from wicking onto the base layer. The function of the first layer of the membrane stack is to spread the sample across a filtration layer. Spreading the sample across the filtration membrane precludes the buildup of cells at any single site by using the whole face of the filtration layer instead of a small area. The filtration layer filters out particulate matter by size-based exclusion, allowing filtered liquid to pass through to a collection reservoir or a collection disc matrix. In PSD's known to the art, the result is that a drop of whole blood deposited on the cover is channeled through the entry hole at a controlled rate onto the spreading layer and is spread onto the filtration layer. Particulate matter like red blood cells is excluded by the filtration layer and plasma passes into the collection disc. The most widely used application of this technology is in the collection of plasma from blood and the preparation of dried plasma spots for later analysis.

PSDs known to the art have several drawbacks. First, PSD's known to the art can collect only a single sample at a time. Second, PSD's known to the art have functional limitations on the types and variety of sample preparation steps that can occur while the PSD is being transported from the point of collection to the point of testing.

Prior to analysis (for example, by mass spectrometry), biological samples must undergo sample preparation. Biological samples are generally too complex for direct introduction into a mass spectrometer. It is thus generally the case that subsequent to thawing, aliquots of a biological sample are dispensed into either microtiter plates or a similar micro-scale vessel for further preparation. Stages of sample preparation to which analytes are frequently subjected include analyte extraction, chemical modification, addition of internal standards, and purification or enrichment. Often, such as when microtiter plates are used, these steps occur in parallel. This parallel processing sample preparation can take an hour or more after delivery of the collected sample to a laboratory.

It would be a decided advantage to have an improved multiplex collection device that can collect multiple simultaneous biological samples and perform multiple preliminary preparation steps either at the time of collection or in transit, such as aliquoting the sample into collection portions of predetermined volume, adding internal standards, size-based separation of components, structure-based separation of components, such that fractions of the sample collected in the improved multiplex device are substantially ready for analysis by, for example, chromatography or mass spectrometry, without significant further preparation, within 30 minutes of collection. It would further be a decided advantage to have an improved multiplex collection device that can divide a biological sample into multiple representative fractions and perform either the same or different sample preparation steps on each fraction in 30 minutes or less, while the sample is presumably en route from the point of collection to the point of analysis.

### SUMMARY

Embodiments of the present invention relate to an improved multiplex collection device for a biological sample that can collect multiple simultaneous biological samples from a relatively small sample volume compatible with finger or heel stick methods, can divide the collected sample into multiple representative fractions of predetermined volume, and can perform multiple preliminary preparation steps either at the time of collection or in transit, such as adding internal standards, size-based separation of components, and structure-based separation or modification of components, such that the sample collected in the improved multiplex device is substantially ready for analysis by, for example, chromatography or mass spectrometry, without significant further preparation, within 30 minutes of introduction of the sample to the device. The apparatus described herein can perform, quickly and on a uL scale, preparatory operations such as particle removal, internal standard addition, peptide immobilization or enrichment, analyte fractionation or compartmentalization, and collection of multiple representative analyzable aliquots of predetermined volume, from a single initial drop of the sample.

Embodiments of the invention described herein enable biological samples of various volumes, such as drops of whole blood, to be easily and conveniently collected, divided, and aliquoted on a uL (as opposed to mL) scale and subjected to one or more stages of preliminary preparation in a matter of less than an hour, and preferably less than half an hour, while the improved collection device is en route from the point of collection to the point of testing. Embodiments of the present invention may be used for the collection and preparation of, and aid in the analysis of, a variety of analytes of interest. Analytes of interest include, by way of example, metabolites, vitamins, natural products, drugs, peptides, proteins, oligonucleotides, steroids, RNA species, cDNA, and DNA.

Embodiments of the present invention further comprise a multiplex device for simultaneous collection biological samples comprising a cover comprising an inlet aperture, a spreading layer adjacent to said cover comprising a macroporous membrane, wherein said spreading layer comprises a transport portion and one or more accumulation portions fluidly connected to said transport portion, and one or more removable collection portions adjacent to said spreading layer, wherein each collection portion is at least partially adjacent to an accumulation portion.

Embodiments of the present invention further comprise a multiplex device for simultaneous collection of multiple aliquots of a biological sample comprising a cover comprising an inlet aperture, a spreading layer adjacent to said cover comprising a macroporous membrane, wherein said spreading layer comprises a transport portion and one or more accumulation portions fluidly connected to said transport portion, a first filter layer (21) adjacent to said spreading layer, and one or more removable collection portions adjacent to said filter layer (21), wherein each collection portion is at least partially adjacent to a portion of said filter layer (21) that is at least partially adjacent to an accumulation portion.

Embodiments of the present invention further comprise a device for simultaneous collection of multiple aliquots of a biological sample comprising a cover comprising a first inlet aperture, a second filter layer (21) adjacent to said cover comprising a second inlet aperture corresponding to said first inlet aperture, a spreading layer adjacent to said cover comprising a macroporous membrane, wherein said spreading layer comprises a transport portion and one or more accumulation portions fluidly connected to said transport portion, a first filter layer (21) adjacent to said spreading layer, one or more collection portions adjacent to said first filter layer (21), and one or more collection portions adjacent to said second filter layer (21), wherein each collection portion is at least partially adjacent to a portion of said first filter layer (21) or said second filter layer (21) that is at least partially adjacent to an accumulation portion.

These and other embodiments within the scope of the invention herein will be shown and become apparent in the drawings and specification below.

### BRIEF DESCRIPTION OF DRAWINGS

FIG. 1A shows a cross-sectional diagram of a cover portion of one embodiment of the present invention;

FIG. 1B shows a top-down diagram of one embodiment of the present invention;

FIG. 2A shows a cross-sectional diagram of a PSD known to the prior art;

FIG. 2B shows a top-down diagram of a PSD known to the prior art;

FIGS. 3A-3D show cross-sectional diagrams of multiple configurations of embodiments of portions of the present invention;

FIG. 3E shows a top-down diagram of one embodiment of the present invention;

FIG. 4 shows a cross-sectional diagram of a channel defined by a solvophobic barrier in certain embodiments of the present invention;

FIGS. 5A and 5B show diagrams of embodiments of the present invention including a channel created by stacking complementary solvophobic barriers;

FIG. 6A shows a cross sectional diagram of an embodiment of the present invention including a first filter layer, a second filter layer, and collection portions adjacent to both the first filter layer and second filter layer;

FIG. 6B shows a top-down diagram of an embodiment of the present invention including a first filter layer, a second filter layer, and eight collection portions:

FIG. 7 shows a perspective view of an embodiment of the invention;

FIG. 8 shows the preparation of NPAS and NIT structures within the scope of the present invention.

### DETAILED DESCRIPTION

These and other embodiments of the present invention will now be described with reference to the foregoing.

Embodiments of the present invention achieve the simultaneous collection of multiple representative aliquots of a small-volume sample of a biological fluid by splitting that sample into multiple representative uL-scale fractions, preparing each of those fractions for analysis during transport of the sample collection device, and aliquoting each of those fractions into a collection portion of pre-determined volume.

Embodiments of the present invention are configured for the collection and preparation of biological samples (1). As used herein, biological sample (1) refers to a fluid from a biological source, and includes for example, blood components, saliva, semen, cerebrospinal fluid, urine, tears and homogenized or extracted biosamples (i.e. from a whole organism, organ, tissue, hair, or bone). Biological samples (1) are collected and prepared for eventual analysis. Analysis as used herein refers to qualitative or quantitative examination of the biological sample by methods known to the art, such as mass spectrometry of chromatography, for analytes of interest Analyses of interest as used herein refers to components within the biological sample the qualitative or quantitative analysis of which may have medical (particularly diagnostic) or scientific significance, and includes, by way of example, metabolites, vitamins, natural products, endogenous and exogenous drugs, amino acids, acyl carnitines, lipids, prostaglandins, peptides, proteins, oligo- and polynucleotides including, mRNA, rRNA, chromosomal and extrachromosal DNA, and virus particles of all types.

Embodiments of the present invention operate with or, notably, without, meaningful fluid flow or fluid pressure through the device. In embodiments without meaningful fluid flow or fluid pressure, liquids are transported from the introductory inlet of the device, through various layers as will be described below, to one or more collection portions, through capillary action, sometimes referred to as wicking, as would be understood by one skilled in the art. Embodiments of the present invention further enable the splitting of a small sample biological sample fluid into multiple relatively uniform fractions. The uniformity of the fractions depends on the uniformity of the substance through which the fluid being fractioned is wicked. Embodiments of the present invention maintain uniformity of the spreading layer, as described in more detail below, to enable biological samples contacting the spreading layer to fraction uniformly in multiple directions through the layer, enabling multiple uniform fractions to be simultaneously collected from various points of the spreading layer. As will be appreciated by one skilled in the art, the rate of dispersion within the spreading layer, and, to a degree, the directionality of the spread, can be selectively controlled through changes in permeability at selected portions of the layer.

Embodiments of the present invention comprise generally a cover (3) with a first inlet aperture (5), a spreading layer (7) comprising a transport portion (9) and two or more accumulation portions (11), and collection portions (13) adjacent to the accumulation portions (11).

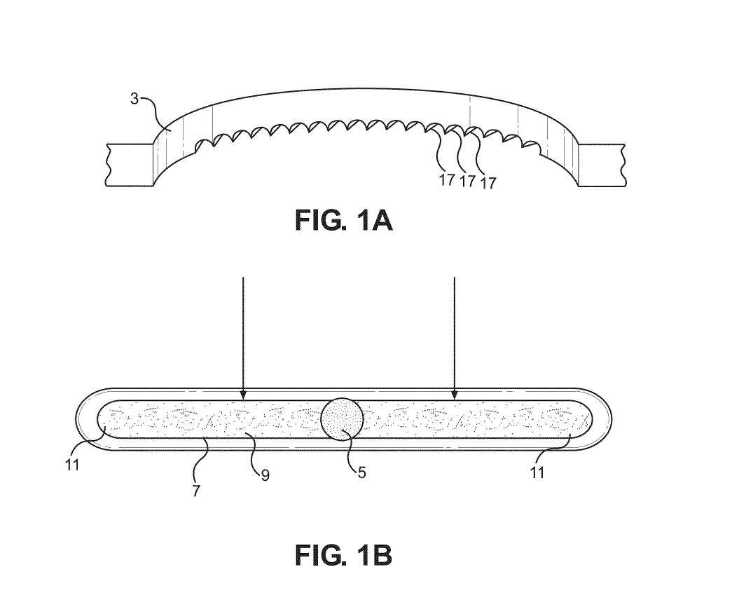

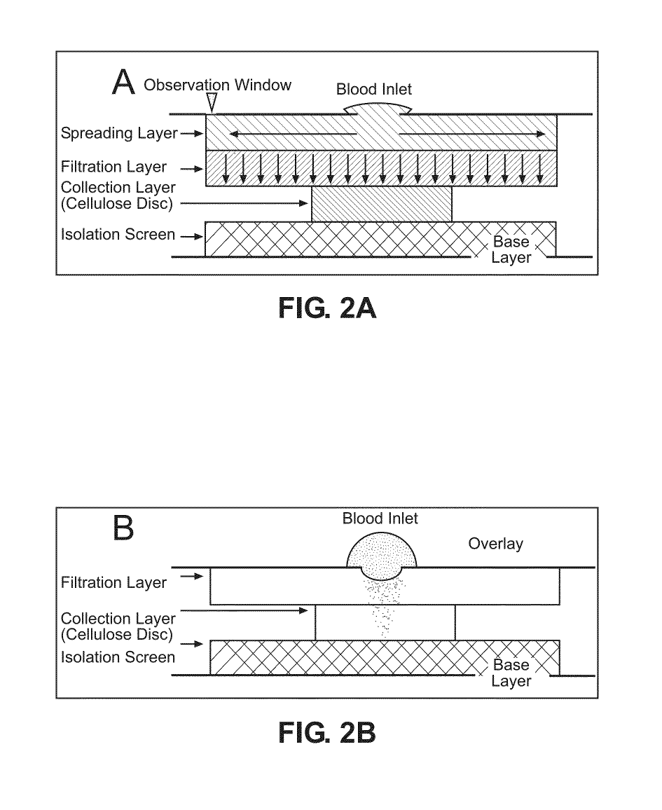

A cover (3) as used herein refers to a layer relatively impermeable to a biological sample. A drop of biological sample (1) is placed on the cover (3) and, as would be appreciated by one skilled in the art, the cover (3) prevents the drop of biological sample (1) from flooding the other layers indiscriminately. Access to the other layers is provided through the cover by an inlet aperture (5). The inlet aperture (5) ensures that the biological sample (1), introduced as a drop on the cover (3) over the area of the inlet aperture (5), is introduced to the spreading layer (7) at a point substantially equidistant from each of the collection portions, (13) ensuring that as the biological sample (1) is divided throughout the spreading layer (7), each fraction travels approximately the same distance to arrive at a collection portion (13). The cover (3) is affixed to the remaining layers in a manner configured to permit swelling of the permeable layers of the device to allow them to reach the maximum effective volume permitted by their dimensions and porosity. To prevent sample underloading, embodiments of the present invention may include one or more observation windows (15) configured to allow an observer to ensure that sufficient amounts of biological sample (1) have been absorbed by the permeable layers of the device. When the biological sample is whole blood, the red color of blood may be seen in such observation windows (15) when the permeable layers are adequately loaded with sample. In some embodiments, the cover (3) may include channels (17) configured to deliver the liquid sample to one or more locations of the spreading layer (7) other than directly under the inlet aperture (5). In these embodiments, the channels (17) comprise inverted troughs in the cover (3), as shown in FIG. 1. Such channels (17) have preferable diameter of between 10 um and 200 um. Liquid fluid introduced to the cover (3) in these embodiments distributes itself into the one or more channels (17), runs along the channels (17), and is delivered into the spreading layer (7) at a location near the end of each of the one or more channels (17). In this manner, in some embodiments, biological sample fractions can be delivered substantially to accumulation portions (11) of the spreading layer (7) without significant contact with the transport portion (9) of the spreading layer (7). These embodiments are particularly suited for apparatuses containing numerous collection portions (13), as the channels (17) help prevent the clogging, occlusion, or oversaturation of the transport portion (9) of the spreading layer (7).

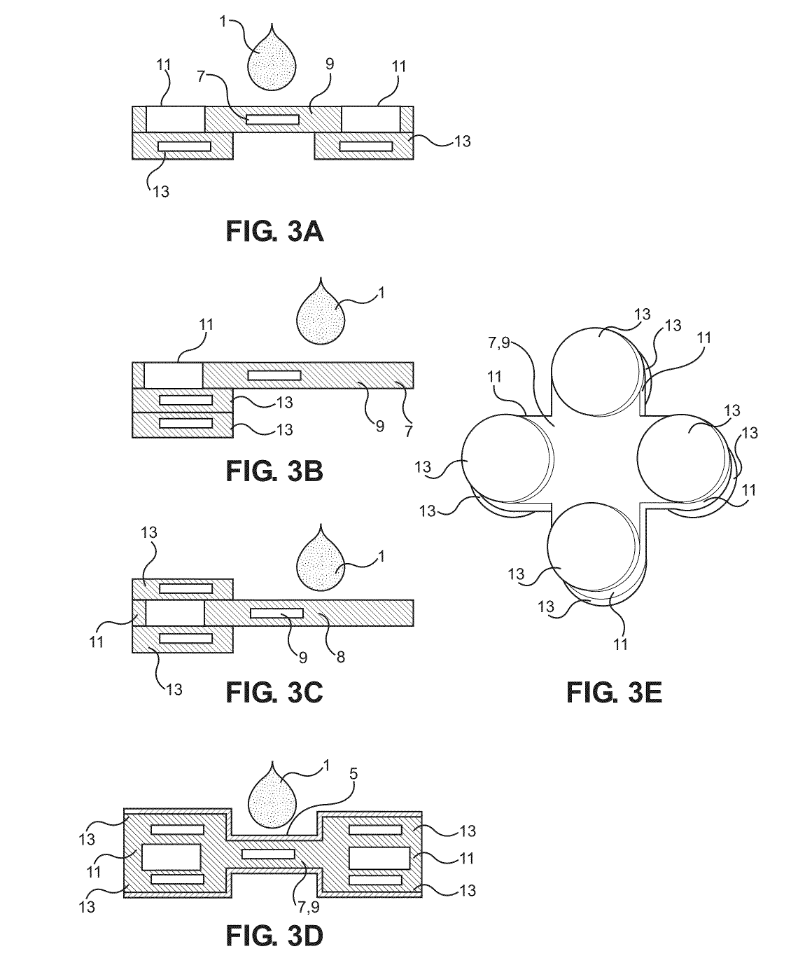

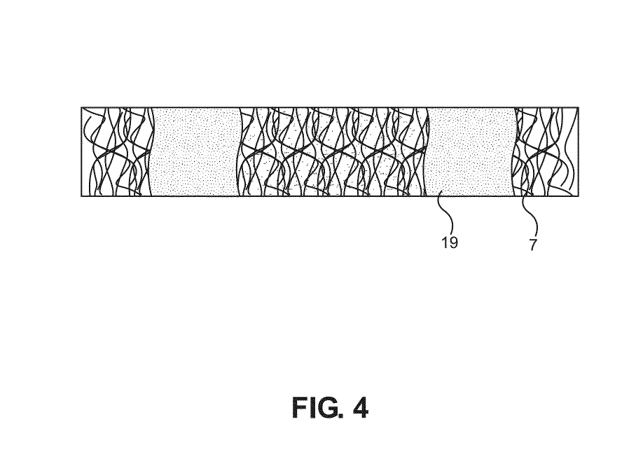

Under the cover (3), and in some embodiments adjacent to it, is the spreading layer (7). The spreading layer (7) comprises a macroporous membrane configured to spread the biological sample uniformly throughout the spreading layer by capillary action. The spreading layer (7) is porous, with pore diameters in the range of 10-100 um. In preferred embodiments, the average pore diameter is 50 um. In some embodiments, the macroporous material of the spreading layer (7) comprises paper. Preferably, the macroporous material of the spreading layer (7) comprises a non-woven, preferably spun-bonded, polymer or polymer blend in a porous matrix. Suitable materials include, by way of example, spun-bonded polyester/rayon blends (such as Dupont 8423) and spun-bonded polyester/cellulose blends (such as Dupont Sonata 8801). As will be appreciated by one skilled in the art, other materials, and particularly other non-woven polymer or polymer blends, could be used within the scope and spirit of this invention. The spreading layer (7) is configured so that the inlet aperture or apertures (5) are located approximately over the center of the spreading layer (7), when viewed from a top-down perspective. The spreading layer (7) comprises a centrally located transport portion (9) and two or more accumulation portions (11). As will be appreciated by one skilled in the art, the number and arrangement of accumulation portions (11) relative to the transport portion (9) is dependent upon the manufactured shape of the spreading layer (7), or upon channels (17) defined within the spreading layer (7). In one embodiment, as shown in FIG. 3A, the spreading layer (7) is elongated with a central portion and two ends, where the central portion comprises a transport portion (9) and each end comprises an accumulation portion (11). In other embodiments, as shown in FIGS. 3B, 3C, and 3D, multiple accumulation portions or multiple collection portions may be located at one or more ends of the spreading layer (7). In another embodiment, as shown in FIG. 3E, the spreading layer (7) is shaped as symmetrical cross, in which the central portion of the vertical and horizontal arms comprises a transport portion (9) and the distal portions of each of the arms comprises an accumulation portion (11). In yet another embodiment, the spreading layer (7) has any desired shape, and a symmetrical shape is defined within the spreading layer (7) through a solvophobic barrier (19). For example, in one embodiment, the spreading layer (7) may be circular, with a symmetrical cross-shaped solvophobic barrier defined within said spreading layer (7) such that the center of the cross is located under the inlet aperture (5). In this embodiment, the central portion comprises a transport layer and each of the four arms of the cross comprises an accumulation layer, as the solvophobic barrier prevents biological sample from being transported to areas of the spreading layer (7) outside of the barrier. A large variety of other shapes and configurations will be apparent within the scope and spirit of this invention.

As used herein “solvophobic barrier” (19) refers to a chemical barrier defined within a layer preventing the travel of polar components beyond the barrier. In preferred embodiments, “solvophobic barrier” refers to ink outlining the periphery of a desired channel or shape such that the entire channel is enclosed within the solvophobic barrier. The solvophobic barrier (19) penetrates substantially completely through the layer to which it is applied and, after drying, forms a substantially hydrophobic barrier. In a most preferred embodiment, solvophobic barriers are formed from a black ink referred to as ‘Lumocolor’ supplied by the German company Staedtler. Solvophobic barriers may be formed in a layer manually, by contact printing, or by inkjet printing. Because the solvophobic barrier defines the potential channel volume, the solvophobic barrier substance is preferably deposited on the layer in a smooth line to diminish lot-to-lot volume variability. Any channels formed by the solvophobic barrier method are stackable through multiple layers or levels. Alternately, a similar barrier may be formed by using heat, sonic excitation, or other methods to melt or partially melt specific portions of the spreading layer to create a defined seal within the porous membrane. Using this method, as would be understood by one skilled in the art, the application of heat or sonic excitation will cause pores to melt substantially closed. Heat or sonic excitation can be applied in a targeted fashion to create defined shapes or pathways in the same manner as a solvophobic barrier.

The transport portion (9) accepts liquid biological sample from the inlet aperture (5), and such liquid biological sample is divided and begins to travel outwards from its point of entry within the transport portion (9) by capillary action. As will be appreciated by one skilled in the art, in a transport portion (9) of substantially uniform construction and permeability, biological sample will travel in all directions from the point of entry at approximately equal rates. In a transport portion (9) of defined shape, such as an cross shape as shown in FIG. 31E, biological sample will travel outwards from the point of entry towards each arm of the cross at approximately equal rates.

Each spreading layer (7) further comprises one or more accumulation portions (11) adjacent to the transport portion (9). Said accumulation portions (11) are defined by the endpoints of the spreading layer (7). As biological sample continues to travel away from the point of entry through the transport layer, it enters or accumulates within the accumulation portion (11) in increasing volume over time. The endpoint of the spreading layer (7) is in some embodiments the physical edge of the macroporous membrane that comprises the spreading layer. In other embodiments, the “edge” of the spreading layer (7) that creates an accumulation portion is defined by a solvophobic barrier within the layer, beyond which biological sample is precluded from passing. In some embodiments, as discussed above, sample introduced to the cover (3) may travel through channels (17) in the cover (3) to substantially circumvent the transport portion (9) and be delivered directly to one or more accumulation portions (11), or near one or more accumulation portions (11).

The device further comprises a collection portion (13) adjacent to and in fluid contact, which may comprise direct or indirect physical contact, with the one or more accumulation portions (11). The collection portion (13) is a macroporous membrane configured for collection of an aliquot of biological sample of desired predetermined volume. The collection portion (13) may be made of, for example, paper. In a preferred embodiment, the collection portion (13) comprises absorbent filter paper constructed substantially of cotton linter with a basis weight of 180 g/m² and Gurley Densometer of 200 seconds, in a thickness of 0.63 mm. In another embodiment, the collection portion (13) comprises absorbent filter paper constructed substantially of cotton linter with a basis weight of 90 g/m² and Gurley Densometer of 1750 seconds, in a thickness of 0.13 mm. In preferred embodiments, the collection portion (13) has a diameter of 6.35 mm and a water collection volume of approximately 2.5 uL. The collection portion (13) is porous with pore a pore diameter in the range of 10-100 um. In a preferred embodiment, the collection portion (13) has an average pore diameter size of 50 um. The collection portion (13) is, in some embodiments, in direct physical contact with the accumulation portion (11) of the spreading layer (7) such that a fraction of biological sample passes into the collection portion (13) from the spreading layer (7) by wicking. In embodiments including one or more filter layers (21), a collection portion (13) may be in indirect physical contact with an accumulation portion (11) of a spreading layer (7) by direct contact with a filter layer (21) that is in direct contact with the accumulation portion (11). In these embodiments, liquid will flow from the accumulation portion (11) through the filter layer (21), to the collection portion (13) by capillary action. Ensuring continuing between layers—whether between a spreading layer (7) and collection portion (13), the spreading layer (7) and a filter layer (21), or a filter layer (21) and a collection portion (13), is preferably achieved by one or more of spot welding during fabrication and application of pressure forcing the junctions together.

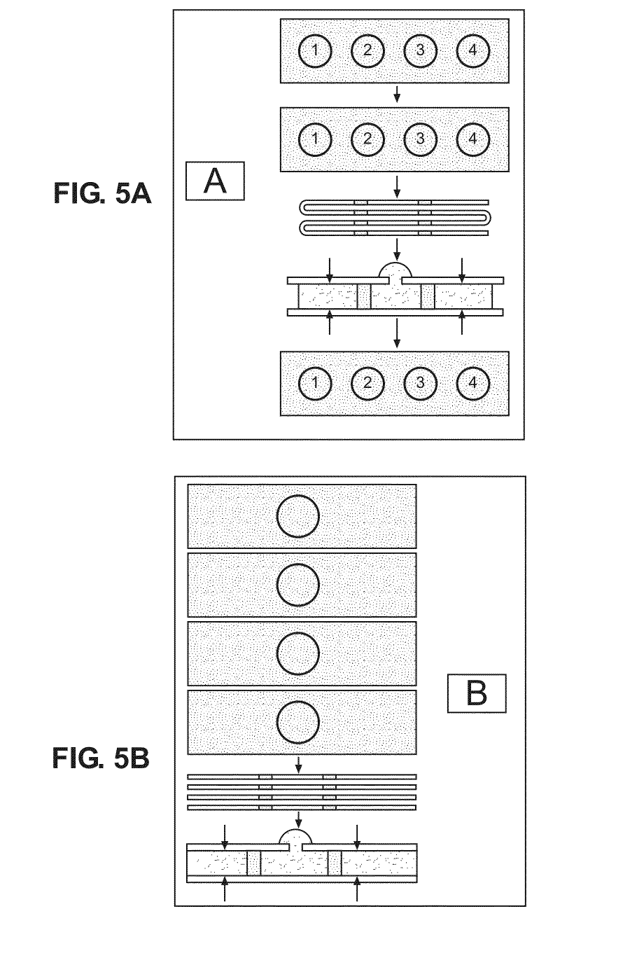

The collection portion (13) may be formed to a desired shape, such as by cutting. Optionally, as shown in FIG. 5, one or more collection portions (13) may be defined by a barrier, such as a solvophobic barrier or a barrier created by the application of heat or sonic excitation, as a specifically shaped area within a larger sheet of material. In some embodiments, the collection portion (13) is physically manufactured as a disc. In other embodiments, the collection portion (13) is defined by a solvophobic barrier of desired shape, such as a circle. As will be appreciated by one skilled in the art, multiple collection portions (13) may be placed into contact with each accumulation portion (11). For example, as shown in FIGS. 3A, 3C, and 3D, one accumulation portion (11) may have a corresponding collection portion (13) in direct or indirect contact with each of its top and bottom surfaces. Further, multiple collection portions (13) may be placed into contact with each other by, for example, stacking multiple collection portions (13), as shown in FIG. 3B. As will be appreciated by one skilled in the art, liquid biological sample will pass from one collection portion (13) to another collection portion (13) stacked against it in substantially the same manner in which such liquid passes by capillary action from the accumulation portion (11) to the collection portion (13). Layers stacked within the device, and particularly stacked collection portions (13), may be formed by using separate sheets of material for each layer, or may be formed by folding a sheet of the same material into multiple layers. In embodiments in which multiple collection portions (13) are formed by folding, solvophobic barriers may be used to define each collection portion (13) and configured such that the solvophobic barriers substantially stack one upon the other, such as shown in FIGS. 5A and 5B. In one embodiment, the spreading layer (7) and collection portions (13) are all formed from a single sheet of material that is stacked by folding. In this embodiment, the outline of the spreading layer (7) and the outlines of the collection portions (13) are defined by solvophobic barriers. The relative volume ratio of each collection portion (13), and the collection portions (13) collectively, to the spreading layer (7) is determined by relative size and permeability, as would be appreciated by one skilled in the art. The collection portion (13) is preferably physically removable from the device by delamination, cutting, tearing, or peeling. In a preferred embodiment, the collection portion (13) is attached to a substantially impermeable substrate, such as hardboard, cardboard, waxed paper, or plastic. The other layers of the device are removably attached to the substrate such that alter the collection portions (13) are loaded with sample, the remaining layers can be peeled away, leaving the collection layers exposed on the substrate. Other methods and manners of removal of the collection portion (13), as will be apparent to one skilled in the art, are within the scope and spirit of this invention.

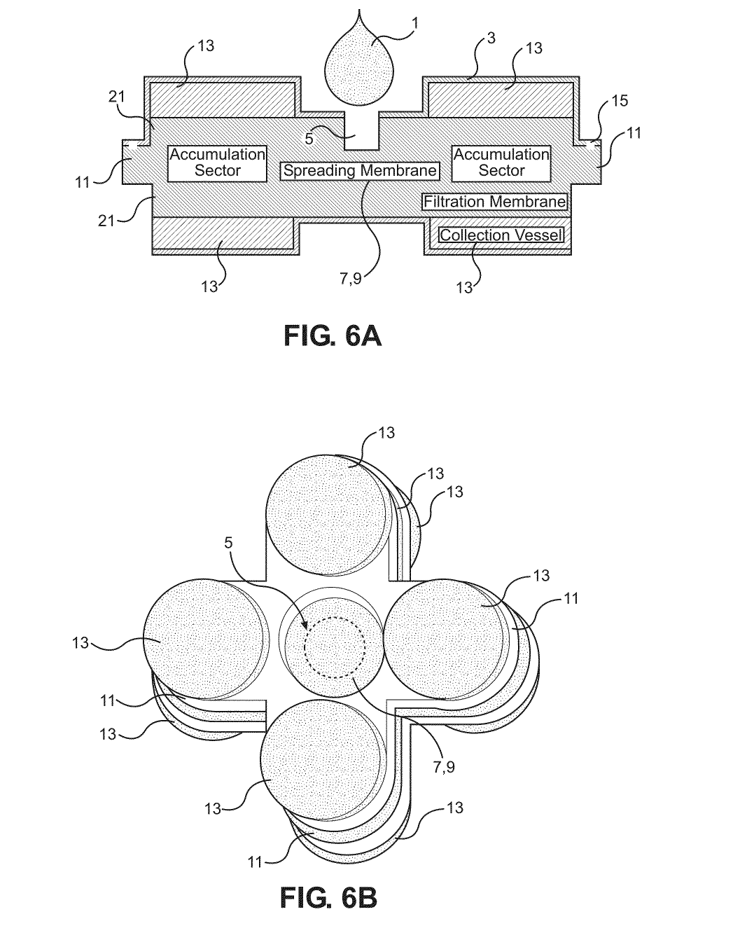

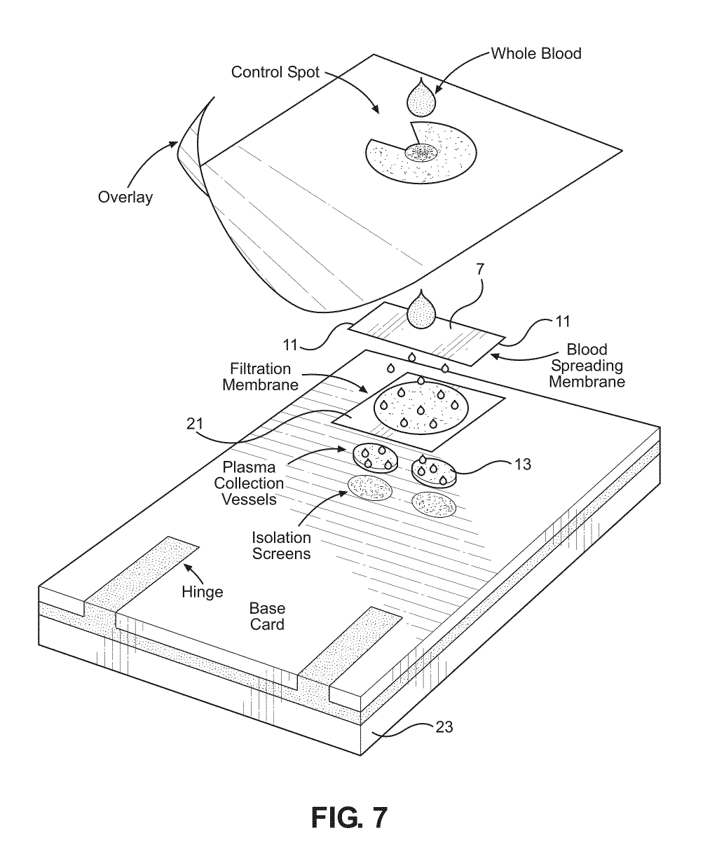

The present application makes reference to layers or portions being “adjacent.” As used herein, “adjacent” means either in direct physical contact, such as when an accumulation portion (11) and collection portion (13) are spot welded or pressed against each other, or in indirect contact, such as in the embodiment shown in FIG. 6A, wherein the collection portion (13) is in direct contact with a portion of a filter layer (21) that is itself in direct contact with an accumulation portion (11).

Optionally, the present device further comprises one or more filter layers (21). A filter layer (21) comprises a material with porosity different than, and preferably of lesser pore diameter than, the macroporous material of the spreading layer (7). The pore size of the filter layer (21) is between 0.5 microns and 5 microns, and preferably between 0.5 and 2 microns. A filter layer (21) prevents particulate matter or chemical components with a size larger than the pore size of the filter layer (21) from passing into the collection portions (13). Embodiments of the present invention may include only a filter layer (21) disposed between the spreading layer (7) and one or more collection portions (13), but not disposed between the spreading layer (7) and the cover (3). Embodiments of the present invention may include only a filter layer (21) disposed between the spreading and one or more collection portions (13) so as to also be disposed between the spreading layer (7) and the cover (3). In these embodiments, the filter layer (21) preferably includes a second inlet aperture (5), as shown in FIG. 6B. Embodiments of the present invention may, as depicted in FIG. 6B, include both a first filter layer (21) disposed between the spreading and one or more collection portions (13) but not disposed between the spreading layer (7) and the cover (3) and a second filter layer (21) disposed between the spreading and one or more collection portions (13) so as to also be disposed between the spreading layer (7) and the cover (3). In these embodiments, the second filter layer (21) also includes a second inlet aperture (5). In embodiments in which the cover (3) comprises channels (17), the second filter layer (21) may comprise multiple inlet apertures (5), one corresponding to the endpoint of each channel (17).

In preferred embodiments herein, each collection portion (13) is removable from the device. The preferred means of removing collection portions (also referred to at times as “vessels” or collection vessels”) is by detachably attaching the collection portion (13) during the manufacturing process to enable delamination and removal of the collection portion (13) after use. The collection portion (13) is removably attached during manufacture, such as by spot welding, to, in some embodiments, an accumulation portion (11) of the spreading layer (7), or, in other embodiments, a portion of a filter layer (21) adjacent to an accumulation portion (11) of the spreading layer (7). Preferably, the collection portion (13) is attached to a substrate, such as, for example, paper, so that once the device is saturated, peeling the paper will delaminate the collection portion (13) from the remainder of the device, yielding collection portions (13) loaded with aliquots of sample. In embodiments were multiple collection portions (13) are of identical dimensions and made of the same material, the collection portions (3) will yield substantially identical masses or aliquots of substantially uniform sample after use.

As will be appreciated by one skilled in the art, a wide variety of configurations are available within the scope and spirit of the present invention. For example, in one embodiment, the spreading layer (7) is an elongate shape with an accumulation portion (11) at each end and there are two collection portions (13), one adjacent to each accumulation portion (11). In another embodiment, a spreading layer (7) of the same elongate configuration may be adjacent to four collection portions (13), with one collection portion (13) adjacent to the top surface of each accumulation portion (11) and one collection portion (13) adjacent to the bottom surface of each accumulation portion (11). In another embodiment, a spreading layer (7) of the same elongate configuration may be adjacent to eight collection portions (13), with two collection portions (13) vertically stacked one on top of the other adjacent to the top surface of each accumulation portion (11), and two collection portions (13) vertically stacked one on top of the other adjacent to the bottom surface of each accumulation portion (11).

In still another embodiment, the spreading layer (7) is shaped as a symmetrical cross, in which each arm of the cross comprises an accumulation portion (11). In this embodiment, the device may have four collection portions (13), one collection portion (13) adjacent to one surface of each accumulation portion (11) (each arm of the cross). In another embodiment, a device with a spreading layer (7) of the same cross configuration may have eight collection portions (13), one collection portion (13) adjacent to the top surface of each arm of the cross and one collection portion (13) adjacent to each bottom surface of each arm of the cross. In another embodiment, a similarly-configured cross may have sixteen collection portion (13) by stacking a second layer of collection portions (13) on top of the first layer of collection portions (13).

By altering the shape and configuration of the spreading layer (7), and optionally by stacking the collection portions (13), a device may have virtually any number of collection portions (13) within the scope and spirit of this invention. The number of collection portions (13) is ultimately limited primarily only by the volume of biological sample intended to be introduced into the device.

In some embodiments, the device may further comprise a gel layer (23). The gel layer (23) is comprised of a porous gel matrix on a rigid backing. Preferably, the gel layer (23) is comprised of polyacrylamide gel on rigid backing, wherein the pore size of the gel is less than or equal to 10 kiloDaltons. The porous matrix of the gel layer (23) is impregnated with hydrophobic components, such as reverse chromatography particles and preferably with porous silica particles of 2-10 um in size, with pores of 30 nm and an octadecyl silane bonded phase. In one embodiment, the gel layer (23) is fabricated by suspending 10 um reversed phase chromatography (RPC) packing in agarose at 50° C. When this suspension is poured on a glass plate, a layer is formed that upon cooling forms a gel in which the RPC particles are trapped in the agarose gel. The amount of agarose in the suspension solution determines the porosity of the agarose gel.

In embodiments comprising a gel layer (23), prior to introduction of a biological sample (1), the gel layer (23) is separated from each collection portion (13) by at least one impermeable layer. In a preferred gel layer embodiment, the rigid backing of the gel layer is hingedly attached to the device such that the rigid backing of the gel layer is in contact with the substrate to which each collection portion (13) is attached. In some embodiments herein, the collection portions (13) are removed from the remaining layers of the device by delaminating or peeling the cover (3), separating layer, and, filter layers (21) (if present) from the substrate containing the collection layer, leaving the collection layer exposed. In embodiments including the gel layer (23), the gel layer (23) is placed into contact with the collection portion (13) Components of the collected sample within the collection portion (13) will be transported by capillary action to the gel layer (23) and will there be retained by the embedded hydrophobic components. However, as will be understood by one skilled in the art, components larger than approximately 10 kiloDaltons will be unable to pass into the porous matrix of the gel layer, and will remain substantially in the collection portion (13). As described in more detail below, these embodiments can be used in conjunction with loading of one or more of the collection portion (13) or spreading layer (7) with digesting agents and binding agents to substantially separate analytes of interest from other peptides or compounds, and to substantially exclude the undesired peptides and other small biological components from the collection portion (13), within the device without the need from chromatography.

Embodiments of the present device can be configured within the scope and spirit of this invention to perform a variety of sample preparation operations within the device, and can perform these operations while the device is in transit from the point of collection to the laboratory such that the aliquots remaining in the collection discs are, within approximately 30 minutes of collection, substantially ready for analysis by mass spectrometry. Such sample preparation steps include, for example, prevention of cellular aggregation, removal of unwanted cells or particles, and removal of interfering components such as abundant proteins.

Embodiments of the present invention may be configured to prepare a sample for analysis by preventing cellular aggregation. Where the biological sample is whole blood, embodiments of the present invention may, for example, be configured to prevent blood clotting within a collected sample. Prevention of clotting is achieved by blocking clotting factor initiation within the device. This is achieved by loading one or more layers of the device with an anticoagulant prior to introduction of a biological sample (1). Appropriate coagulants include chelates of calcium such as, by way of example, EDTA, citrate, and oxalate. In a preferred embodiment, the spreading layer (7) is loaded with an anticoagulant during its manufacture. When a whole blood sample is introduced into the device and spreads through the spreading layer (7), it contacts the coagulant and the pre-loaded anticoagulant dissolves in the plasma portion of the blood sample, precluding clotting as the sample travels through the spreading layer (7) to its ultimate destination in the collection portions (13).

Embodiments of the present invention may further be configured to prepare a sample for analysis by removing particulates. For example, the embodiments shown in FIGS. 6A and 6B include a first filter layer and a second filter layer disposed, respectively, along the top and bottom surfaces of the spreading layer (7), located at least in part between the accumulation portions (11) of the spreading layer (7) and the collection portions (13). These filter layers (21) remove particulate matter during the course of sample collection. In this embodiment, the spreading layer (7) transports sample to the accumulation portions (11) before substantial transport of sample volumes from the accumulation portions (11) to the collection portions (13) across the filtration layer begins. The rapidity of transport through the spreading layer (7) decreases the prospect of a large volume of cells collecting in a small area on one of the filter layers (21) and causing the filter layer (21) to suffer one or more local clogs. Accordingly, the spreading layer (7) is configured, such as through material selection, to have a higher transport rate than the transport rate of any filter layer (21). Experimentally, it was found the transport rate of liquid in the preferred spreading layer (7) was 100 to 150 times greater than the transport rate of the same liquid in the preferred filter layer (21). The mass flow rate at which liquid passes through a membrane is given by the equation:

$$Q = N \frac{πρ g {R}_{p}^{4}}{{8}_{μ} {L}_{w}} ( {L}_{w} + x )$$

where μ is the viscosity, ρ the liquid density, L_{w} is membrane length, Rₚ is mean pore radius, g the acceleration of gravity, N equals the number of capillaries passing along the wick, and x is the liquid height in the reservoir serving liquid to the membrane. Accordingly, the pore radii of the spreading layer (7) is very large relative to the pore radii in any filter layer (21).

Embodiments of the present invention may further be configured to prepare a sample for analysis by removing interfering proteins. In some embodiments herein, the spreading layer (7) is loaded during manufacture by a mixture of polyclonal antibodies (pAb) immobilized to 80-100 nm nanoparticles, where the nanoparticles are coated with a carbonyl rich hydrophilic coating. Hydrophilic nanoparticles of this size are colloidal. The pAb mixture consists of a set of antibodies targeting a specific protein in plasma and another set directed against surface proteins on red blood cells.

A first antibody bound to the surface of the nanoparticles in highest abundance target specific protein or proteins for removal, as will be appreciated by one skilled in the art. A second antibody in lesser abundance pAb immobilized on the nanoparticles is directed against proteins on the exterior surface of red blood cells. Suitable antibodies for first and second antibodies will be recognized by those skilled in the art, and include albumin, immunoglobulins, α-1-antitrypsin, α-1-fetoprotein, α-2-macroglobulin, transferrin, β-2-microglobulin, haptoglobin, ceruloplasmin. Nanoparticles coated with antibodies, including first and second antibodies are described herein, are referred to here as nanoparticulate affinity sorbents, or “NPAS.”

In these embodiments, when a whole blood sample is introduced to the device, proteins within the sample targeted by the first antibody begin to bind to NPAS as the sample moves through the spreading layer (7). NPAS particles begin to bind to aggregate as multiple NPAS particles bind to the same protein. NPAS aggregates simultaneously bind to one or more red blood cells by operation of the second antibody. The large resulting aggregate of NPAS, undesired targeted proteins, and red blood cells are size-excluded by a filter layer (21) from the collection portion (13). Complete removal of interfering proteins is generally not necessary to render a plasma sample suitable for analysis. Reduction in concentration of undesired proteins is typically sufficient.

Embodiments of the present invention may be configured to prepare a sample for analysis by adding one or more internal standards. As will be appreciated by one skilled in the art, an “internal standard” refers to a substance added in a known amount prior to analysis of a sample, wherein a mass spectrometric signal of the known internal standard can be compared to the mass spectrometric signal, if any, of analytes of interest within the sample, and, through this comparison, quantification of analytes of interest can be determined. An ideal internal standard is a substance with a highly similar, and, if possible, identical chemical structure to the analyte of interest, that differs only by the presence of “heavy” atoms at specific sites in the internal standard. For instance, a deuterium isotope of vitamin D, in which a deuterium atom is substituted for a hydrogen atom, is an appropriate internal standard for vitamin D. Ideally, the internal standard (IS) is 3 or more atomic mass units (amu) heavier than the analyte and identical in structure with the exception of the ¹³C, ¹⁵N, ¹⁸O, or ²H atoms that have been substituted for specific ¹²C, ¹⁴N, ¹⁶O, or ¹H atoms in the analyte. ¹³C is ideal, followed by ¹⁵N and ¹⁸O. The least favorable is ²H because of the chromatographic isotope effect it conveys. The increase in mass in the internal standard from the addition of heavy isotopes will be equal to n amu. Although an analyte of interest and a corresponding internal standard differ in mass and are recognized individually by mass spectrometry, their fragmentation patterns and relative yields of fragment ions are substantially identical. When an amount (wᵢₛ) of an internal standard (is) of molecule weight (M_{w}_{ᵢₛ}) is added to a collection portion (13) during manufacture, the concentration (Cᵢₛ) of the internal standard can be calculated using to the equation

$${C}_{is} = \frac{{w}_{is}}{{VM}_{{w}_{is}}}$$

In embodiments herein, one or more of the spreading layer (7) or collection portions (13) are loaded during manufacture with one or more internal standards. In some embodiments with multiple collection portions (13), different internal standards are used. For example, in an embodiment comprising four collection portions (13), each collection portion (13) may contain the same internal standard or combination of internal standards, or each collection portion (13) may contain an internal standard of combination of internal standards that may be different from the internal standard or internal standard combination of another collection portion (13) within the same device. When a liquid biological sample fraction enters the collection portion (13) during use of the device, the internal standard is dissolved, provided a known concentration for comparison and quantification during analysis, as will be appreciated by one skilled in the art.

Embodiments of the present invention may be configured to prepare a sample for analysis by chemically structurally modifying analytes of interest by derivatization. As will be appreciated by one skilled in the art, derivatization enhances ionization during mass spectral analysis, facilitates chromatographic analysis, isotopically codes analytes, or provides a combination of these outcomes. In all cases derivatization increases the mass of analytes.

In embodiments herein containing derivatizing agents, derivatizing agents are added to one or more of the spreading layer (7) or the collection portions (13) during Fabrication. Optionally, derivatizing agents may be added after sample collection. Like embodiments containing an internal standard, derivatizing agents may be added to one or more collection portions (13), and each collection portion (13) may be loaded with a derivatizing agent that is the same as or different from derivatizing agents loaded in other collection portions (13).

For example, biotin hydrazide may be used as a derivatizing agent to enhance analysis of carbonyl-bearing analytes of interest. Biotin hydrazide is added to at least one collection portion (13) during fabrication. When a blood sample fraction containing a carbonyl-bearing analyte of interest is introduced to the collection portion (13), biotin hydrazide derivatizes the carbonyl containing component by forming a Schiff base. The derivatized component may, in a laboratory, be reduced, for example with NaCNBH₄ and extracted from the collection portion (13). The derivatized analyte can be easily enriched by avidin chromatography and subsequently analyzed by mass spectrometry.

Embodiments of the present invention may be configured to prepare a sample for analysis by chemically structurally modifying analytes of interest by trypsin digestion. In preferred embodiments herein, trypsin is immobilized. Immobilizing trypsin decreases autolysis, increases thermal stability of the enzyme, and allows the use of much higher concentrations of trypsin. Trypsin was immobilized on 80 nm silica nanoparticles through Schiff base formation. The requisite high concentration of carbonylated silica nanoparticles that led to Schiff base formation with lysine residues on trypsin was obtained by applying oxidized Ficoll to the surface of alkylamine derivatized silica particles. Subsequent to Schiff base formation with trypsin the —N═CH— bonds were reduced with NaCNBH₄.

The resulting tryspin-coated nanoparticles may be loaded into one or more of the spreading layer (7) or collection portions (13) during fabrication. Nanoparticle-immobilized trypsin (“NIT”) may be added to one or more collection portions (13). Preferably, NIT are in these embodiments loaded into the collection portion (13). The 80 nm NIT are in these embodiments smaller than the pore size of the porous matrix of the collection portion (13). When the solution in which NIT are suspended dries after being introduced to a collection portion (13) during fabrication, NIT are deposited uniformly throughout the collection portion (13) porous matrix.

As protein fractions (plasma, in the case of blood) enter a collection portion (13) and contact NIT, proteolysis begins. Proteolysis continues for approximately fifteen to twenty minutes. Preventing the collection portion (13) from drying completely, such as by placing the device or a removed collection portion (13) in a wet environment or an environment containing water vapor, allows proteolysis to continue for even longer times. Upon arrival at a laboratory, the resulting trypsin digest is removed from the collection portion (13) for analysis. For example, as will be appreciated by one skilled in the art, trypsin digest recovered from a collection portion (13) may be easily fractionated by reversed phase chromatography (RPC) with introduction of the RPC effluent into an MS/MS by electrospray ionization. Target proteins are then identified and quantified through their signature peptides. One notable aspect of embodiments of the present invention is that trypsin digest within the collection portion (13) is useable for analysis for identification and quantification of proteins even if proteolysis is not complete. In these embodiments of the invention, it is therefore not necessary to wait for proteolysis to be complete before the sample fraction within the collection portion (13) is analyzed.

Large numbers of peptides are formed when a protein is digested; normally in the range of 50-100 peptides for each protein. Since there can be thousands of proteins in plasma, hundreds of thousands of peptides can be formed by trypsin digestion. It will be the case in the identification and quantification of one to a few proteins that the number of signature peptides being targeted for trypsin adsorption is in the range of no more than 50 peptides. Thus, embodiments of the present invention further allow the sample preparation step of excluding from the collection portion (13) a large proportion of these untargeted peptides to facilitate analysis.

In some embodiments wherein the device comprises a gel layer (23), NIT and NPAS may be loaded into a collection portion (13) prior to introduction of a sample. When a sample enters the collection portion (13) and contacts NIT, proteolysis begins. Targeted peptides related to analytes of interest (or ‘signature peptides’) are then adsorbed by selected NPAS. The NPAS-peptide complex has a size greater than 10 kiloDaltons. After proteolysis is substantially complete, but before the collection portion (13) has completely dried, the collection portion (13) is removed from the remaining layers of the device by delamination and is placed in contact with the gel layer (23). Untargeted peptides and other biological components smaller than 10 kD pass into the gel layer (23) and are retained by the embedded hydrophobic agents. The NPAS-peptide complex, bearing peptides related to analytes of interest, is too large to enter the gel layer and remains in the collection portion (13). The NPAS-peptide complex can then be disassociated at the testing site, the NPAS excluded, signature peptides eluted, refocused on a PEDC, and eluted into the LC-MS/MS system.

Embodiments of the present invention may further sequence the steps of trypsin digestion and capture of signature peptides to avoid the digestion of NPAS antibodies by trypsin. Alternately, NPAS may be formed using one or more aptamers instead of one or more antibodies to avoid digestion. Although it is known to the art to sequence these steps by use of separate compartments or vessels in systems that transport liquid through fluid flow or pressure, the present invention primarily transports liquid by capillary action. In embodiments of the present invention, multiple collection portions (13), wherein each set of collection portions (13) is loaded with only one or NIT or NPAS, may be stacked, as described elsewhere herein, to accomplish the sequencing of trypsin digestion and NPAS adsorption as sample wicks through the stacked layers. In these embodiments, each collection portion (13) is less than 10 um in volume. Further, in these embodiments, each collection portion (13) is separated from adjacent collection portions (13) by no more than 0.1 to 10 um.

In a representative such embodiment, a first set of collection portions (13) adjacent to an accumulation portion (11) is loaded with NIT, and trypsin digestion occurs in that first set of collection portions (13). The first set of collection portions (13) may contain one, two, or more stacked collection portions (13). The number of collection portions (13) in this first set of collection portions (13) in configured to allow sufficient time for proteolysis to occur during the diffusion of the sample throughout the first set of collection portions (13). Preferably, the first set of collection portions (13) contains sufficient stacked layers to have a diffusion time of 10 to 15 minutes. The diffusion equation approximates the time t_{d} it takes a molecular species with a diffusion constant D to migrate a distance x:

$${t}_{d} = \frac{{x}^{2}}{6 D} .$$

As will be appreciated by one skilled in the art, once the diffusion constant, the intended identity of the head sample, and the thickness of each collection portion (13), and the porosity of each collection portion (13) is known, the number of required layers of stacked collection portion (13) can be calculated. A second collection portion (13) is stacked on the first collection portion (13) set opposite the accumulation portion (11). This second collection portion (13) is loaded with NPAS and adsorbs to signature peptides. The second collection portion (13) may comprise a second set of collection portions (13) stacked one upon the other. As will be appreciated by one skilled in the art, there may further exist one or more porous layers not loaded with NIT or NPAS disposed between the first set of collection portions (13) and the second collection portion (13) or set of collection portions (13) to further enhance physical separation of NIT from NPAS.

Alternately, a collection portion (13) may be fabricated with small physical structures embedded within the porous matrix of the collection portion (13), such structures being separated from each other on a micron scale. In some embodiments, one or more NITs may be physically located and immobilized at a first location in a collection portion (13), and one or more NPAS's may be physically located and immobilized at a second location in the same collection portion (13), with the first and second locations separated by a distance of less than 1 micron. Thus, trypsin digestion and NPAS adsorption may occur separately within the same collection portion (13). Preferably in these embodiments, multiple redundant collection portions (13) so configured are stacked, enabling a larger volume of prepared sample to be eluted from the device without increasing the compartment size of each collection portion (13) to a volume that would degrade diffusion transport.

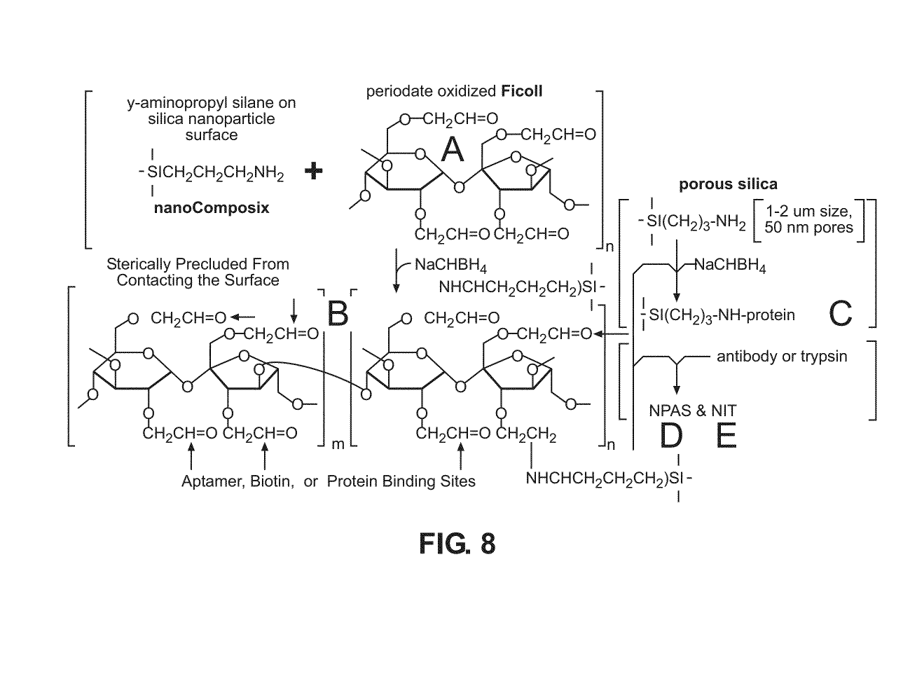

The chemistry involved in preparing nanoparticulate affinity sorbents (NPAS) and nanoparticulate immobilized trypsin (NIT) is shown in FIG. 8. Sodium periodate is used to oxidize 400 kD Ficoll (product “A”) to alkyl amine derivatized surfaces in the presence of NaCNBH4, yielding product “B”. Coupling occurs through Schiff base formation followed by reduction of the —C═N— bond. Sorbents with multiple immobilized proteins are formed by contacting product B with 1-2 um silica particles of 50 nm pore diameter. Because the nanoparticles are too large to enter pores in the 1-2 um silica, only the outside of the particle is coated. The function of these bound nanoparticles is to preclude NPAS and NIT from contacting the protein inside the porous silica. Ficoll coated nanoparticles have large numbers of residual aldehydes that can be used to immobilize proteins on the surface of nanoparticles. Antibodies and trypsin are immobilized in this way; see reaction products “D” and “E” of FIG. 8. Aldehydes and Schiff bases were reduced with NaBH4 after the reaction. Alternative synthesis of the silica structure described herein, and the attachment of antibodies or aptamers to it, is described in detail in U.S. Patent Application Ser. No. 62/030,930.

Optionally, embodiments of the present invention may be used to identify intact proteins by first capturing the targeted protein (Pₜₐᵣ) with an NPAS antibody and then removing all the other proteins in the mixture, as described above.

Optionally, embodiments of the present invention may be used to carry out protein analyses by adding high levels of the trypsin inhibitor benzidine to one or more collection portions (13), with NIT and NPAS physically immobilized within the collection portion (13) as described above. As will be appreciated by one skilled in the art, immobilized aptamer is generally substitutable for immobilized antibodies in NPAS. In these embodiments, where the device is used to collect a whole blood sample and the device contains a filter layer (21), as plasma enters the collection portion (13), the benzamidine will dissolve and inhibit trypsin from digesting proteins at the pH of the plasma. This allows NPAS to capture protein targets (Pₜₐᵣ), (whole targeted proteins) in solution. With an excess of antibody or aptamer concentration, such capture will occur in minutes. Benzamidine is sufficiently small to diffuse into the gel layer and be captured by the embedded hydrophobic materials, depleting benzamidine in collection portion (13) over time. Because of the diffusion distance involved, benzidine concentration in the collection portion (13) will decrease slowly relative to the time required for immune complex formation for adsorption of protein. After targeted proteins have been removed form plasma by NPAS, as benzidine concentration in the collection portion (13) decreases, trypsin activity will return to normal. As trypsin activity increases digestion begins and converts unbound, and thus untargeted, proteins to peptides. When a gel layer is brought into contact with the collection portion (13), untargeted peptides thus formed are small enough to diffuse into the gel layer to be sequestered.

In embodiments in which multiple collection portions (13) are adjacent to each other by stacking, each collection portion (13) may be loaded with a different reagent or may otherwise be configured to perform a different sample preparation operation. For example, in one embodiment, an accumulation portion (11) is loaded with a digesting agent such a trypsin, a first collection portion (13) adjacent to the accumulation portion (11) is loaded with a first antibody to adsorb a first peptide, and a second collection portion (13) stacked vertically on the first collection portion (13) is loaded with a second antibody to adsorb a second peptide. In this manner, each collection portion (13) may be optimized for analysis of a different analyte of interest. A very large number of combinations and subcombinations are possible within the scope and spirit of this invention.

As will be appreciated by one skilled in the art, although various embodiments of the device herein have beer described, a large variety of combinations and subcombinations of the structures, configurations, and features herein may be made within the scope and spirit of this invention. Further, a large number of embodiments not specifically described herein exist within the scope and spirit of the disclosure of this invention.

What is claimed is:

1. A device for simultaneous collection of multiple aliquots of a biological sample, said device comprising:
a cover;
a spreading layer adjacent to said cover comprising a macroporous membrane, wherein said spreading layer comprises a transport portion and at least one accumulation portion is in fluid connection with said transport portion; and
at least one removable collection portion in fluid connection with said at least one accumulation portion.

2. The device of claim 1 further comprising a housing enclosing said spreading layer and said collection portion, wherein said cover is connected to said housing and said cover further comprises an inlet aperture, and said inlet aperture is in fluid connection with said spreading layer.

3. The device of claim 1, wherein said at least one accumulation portion is defined by a solvophobic barrier.

4. The device of claim 2, wherein said at least one accumulation portion is loaded with at least one of an internal standard, a derivatizing agent, a digesting agent, derivatized antibodies, underivatized antibodies, an aptamer, a stabilizer, an immobilizing agent, binding protein, an affinity selector, trypsin, and an anticoagulant, prior to use of the device.

5. The device of claim 4, further comprising a first filter layer adjacent to said spreading layer.

6. The device of claim 5, wherein at least one collection portion is adjacent to said first filter layer.

7. The device of claim 5, further comprising a second filter layer adjacent to at least one of said spreading layer and said first filter layer.

8. The device of claim 7, wherein at least one of said first collection portion and said second collection portion is adjacent to said second filter layer.

9. A device for simultaneous collection of multiple aliquots of a biological sample, said device comprising:
a cover;
a spreading layer adjacent to said cover comprising a macroporous membrane, wherein said spreading layer comprises a transport portion, a first accumulation portion located at a first edge of said spreading layer, and a second accumulation portion located at a second edge of said spreading layer, wherein each accumulation portion is fluidly connected to said transport portion; and
at least a first removable collection portion in fluid connection with said first accumulation portion, and at least a second removable collection portion in fluid connection with said second accumulation portion.

10. The device of claim 9, further comprising a housing enclosing said spreading layer and said first and second collection portions, wherein said cover is connected to said housing and said cover further comprises an inlet aperture, and said inlet aperture is in fluid connection with said spreading layer.

11. The device of claim 9, wherein at least said first accumulation portion is defined by a solvophobic barrier.

12. The device of claim 10, wherein said at least one accumulation portion is loaded with at least one of an internal standard, a derivatizing agent, a digesting agent, derivatized antibodies, underivatized antibodies, an aptamer, a stabilizer, an immobilizing agent, binding protein, an affinity selector, trypsin, and an anticoagulant, prior to use of the device.

13. The device of claim 12, further comprising a first filter layer adjacent to said spreading layer.

14. The device of claim 13, wherein at least said first collection portion is adjacent to said first filter layer.

15. The device of claim 12, further comprising a second filter layer adjacent to at least one of said spreading layer and said first filter layer.

16. The device of claim 15, wherein at least one of said first collection portion and said second collection portion is adjacent to said second filter layer.

17. A device for simultaneous collection of multiple aliquots of a biological sample, said device comprising:
a cover with a first side and a second side opposite the first side, said cover comprising an inlet aperture through the first side of said cover providing access to said second side, and said cover further comprising a plurality of channels in said second side, each of said channels comprising a channel first end in fluid connection with said inlet aperture and a channel second end remote from said first end;
a spreading layer comprising a macroporous membrane in fluid connection with said channel second end, wherein said spreading layer at least a first accumulation portion located at a first edge of said spreading layer, and a second accumulation portion located at a second edge of said spreading layer; and
at least a first removable collection portion in fluid connection with said first accumulation portion, and at least a second removable collection portion in fluid connection with said second accumulation portion.

18. The device of claim 17, further comprising a housing enclosing said spreading layer and said first and second collection portions, wherein said cover is connected to said housing.

19. The device of claim 18, wherein at least said first accumulation portion is defined by a solvophobic barrier.

20. The device of claim 17, wherein said at least one accumulation portion is loaded with at least one of an internal standard, a derivatizing agent, a digesting agent, derivatized antibodies, underivatized antibodies, an aptamer, a stabilizer, an immobilizing agent, binding protein, an affinity selector, trypsin, and an anticoagulant, prior to use of the device.

21. The device of claim 20, further comprising a first filter layer adjacent to said spreading layer.

22. The device of claim 21, wherein at least said first collection portion is adjacent to said first filter layer.

23. The device of claim 20, further comprising a second filter layer adjacent to at least one of said spreading layer and said first filter layer.

24. The device of claim 23, wherein at least one of said first collection portion and said second collection portion is adjacent to said second filter layer.
